(19) United States
(12) Patent Application Publication
(10) Pub. No.: US 2011/0069065 A1
(43) Pub. Date: Mar. 24, 2011

(54) IMAGE PROCESSING APPARATUS, COMPUTER READABLE MEDIUM AND METHOD THEREOF

(75) Inventors: Kazuhiro Hiwada, (US); Atsushi Kunimatsu, Chiba (JP); Goh Uemura, Kanagawa (JP); Takashi Takemoto, Kanagawa (JP); Hidenao Bito, Kanagawa (JP)

(73) Assignee: Kabushiki Kaisha Toshiba, Tokyo (JP)

(21) Appl. No.: 12/885,805

(22) Filed: Sep. 20, 2010

(30) Foreign Application Priority Data
Sep. 24, 2009 (JP) 2009-219581
Mar. 30, 2010 (JP) 2010-079836

(51) Int. Cl. G06T 17/20; G06T 17/00

(52) U.S. Cl. 345/420; 345/423

(57) ABSTRACT

According to one embodiment, an image processing apparatus includes a processing unit, a tessellation processing unit and a tessellation data storage unit. The processing unit performs interpolation processing on vertex data of a vector image for each sprite. The tessellation processing unit is hardware to perform tessellation processing that generates primitives based on the vertex data from the processing unit. The tessellation data storage unit stores the primitives generated by the tessellation processing unit for each sprite. The processing unit generates a rendering function to render the vector image based on the stored primitives in the tessellation data storage unit, the stored primitives is generated by rendering processing prior to the present rendering processing.

### CROSS-REFERENCE TO RELATED APPLICATIONS

This application is based upon and claims the benefit of priority from the prior Japanese Patent Application No. 2009-219581, filed on Sep. 24, 2009; and the prior Japanese Patent Application No. 2010-79836, filed on Mar. 30, 2010; the entire contents of all of which are incorporated herein by reference.

### FIELD

Embodiments described herein relate generally to an image processing apparatus, a computer readable medium and method thereof.

### BACKGROUND

Rich content like that reproduced by a personal computer (hereinafter, referred to simply as a “PC”) is expected to be handled by an embedded device having a display function such as a mobile terminal. However, an image processing apparatus mounted on an embedded device is required to be compact and low power-consuming and thus, a sufficient memory or CPU clock rate to reproduce rich content in high quality cannot be ensured. Thus, an attempt is made in recent years to use dedicated hardware for a portion in charge of part or all of processing concerning reproduction of rich content as a measure to be able to reproduce rich content in high quality (see, for example, Japanese Patent Application Laid-Open No. 11-505644).

In the reproduction of rich content, rendering of vector graphics, particularly tessellation processing requires an extremely large amount of computation. Tessellation processing is processing that converts the surface of an object represented by curves (curved surfaces) and vertices of borderlines into a form in which the surface is represented by an aggregate of polygons (hereinafter, referred to as primitives). Improving efficiency of the tessellation processing can be considered to be a key point to be able to reproduce rich content in high quality in an image processing apparatus.

### BRIEF DESCRIPTION OF THE DRAWINGS

FIG. 1 is a diagram illustrating a general processing flow executed when a content file is reproduced.

FIG. 2 is a diagram illustrating a configuration of an image processing apparatus according to a first embodiment of the invention.

FIG. 3 is a diagram illustrating the configuration of tessellation cache hardware.

FIG. 4 is a flow chart illustrating an operation of the image processing apparatus according to the first embodiment of the invention.

FIG. 5 is a flow chart illustrating the operation of the tessellation cache hardware.

FIG. 6 is a flow chart illustrating the operation of the tessellation cache hardware.

FIG. 7 is a diagram illustrating the configuration of the image processing apparatus according to a second embodiment of the invention.

FIG. 8 is a flow chart illustrating the operation of the image processing apparatus according to the second embodiment of the invention.

### DETAILED DESCRIPTION

In general, according to one embodiment, an image processing apparatus includes a processing unit, a tessellation processing unit and a tessellation data storage unit. The processing unit performs interpolation processing on vertex data of a vector image for each sprite. The tessellation processing unit is hardware to perform tessellation processing that generates primitives based on the vertex data from the processing unit. The tessellation data storage unit stores the primitives generated by the tessellation processing unit for each sprite. The processing unit generates a rendering function to render the vector image based on the stored primitives in the tessellation data storage unit, the stored primitives is generated by rendering processing prior to the present rendering processing.

Exemplary embodiments of an image processing apparatus, a computer readable medium and method thereof will be explained below in detail with reference to the accompanying drawings. The present invention is not limited to the following embodiments.

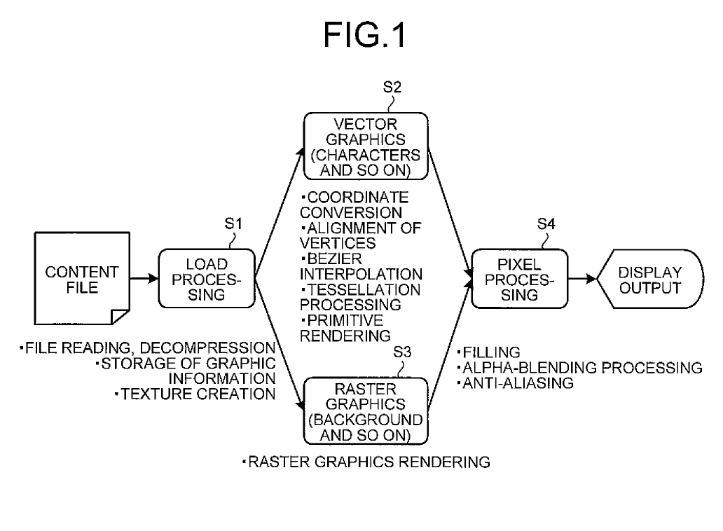

First, a general processing flow executed when a content file is reproduced will be described with reference to FIG. 1.

As shown in FIG. 1, load processing of a content file is first performed (step S1). In the load processing, the content file is read and the read file is decompressed. Then, information (graphic information) contained in the decompressed content file is separated for each sprite (also referred to as a class) and stored in a memory or the like. Texture is also extracted from the decompressed content file and stored in the memory or the like. That is, the texture is generated.

Characters and the like contained in the content file are rendered as vector images (vector graphics) (step S2). Vertices (vertex coordinates) of borderlines contained as graphic information of classes rendered in vector graphics are aligned so as to make Bezier interpolation performed later easier. Then, Bezier interpolation is performed between aligned vertices. Tessellation processing is performed on each surface separated by Bezier-interpolated borderlines to generate primitives to be rendered. Hereinafter, vertex coordinates of borderlines may also be called vertex data.

On the other hand, a background image or the like contained in the content file is rendered as a raster image (step S3). Raster graphics to be rendered is generated based on the texture generated by the load processing.

Then, pixel processing including fill processing, alpha-blending processing, and anti-aliasing processing is performed on generated primitives and generated raster graphics to generate frames to be displayed in a display screen (step S4).

A sequence of processing flow described above requires high performance from the executing computer. While it is easy to reproduce a content file by using a high-performance computer such as a personal computer (PC) in recent years, if, as described above, the content file is executed by an image processing apparatus mounted on a mobile phone or the like with less processing performance compared with the PC, latency increases so that, when reproduced images are viewed as animation, an undesirable situation resulting from delayed processing such as delayed frames arises. That is, the image processing apparatus is unable to reproduce high-quality images.

The inventors of the invention found out by performing various simulations and experiments that when a processing flow of such a full-spec content file is executed by an image processing apparatus, tessellation processing arises as a bottleneck to cause deterioration in overall processing speed. In the first embodiment, regarding sprites on which tessellation processing has been performed, the memory is caused to store data (tessellation data) after the tessellation processing. Then, when the same sprite is rendered again, tessellation data that is stored in the memory is used. The first embodiment is characterized in that the number of times of performing tessellation processing is thereby reduced. Hereinafter, an expression of caching tessellation data will be used to mean that tessellation data is made to store for reuse.

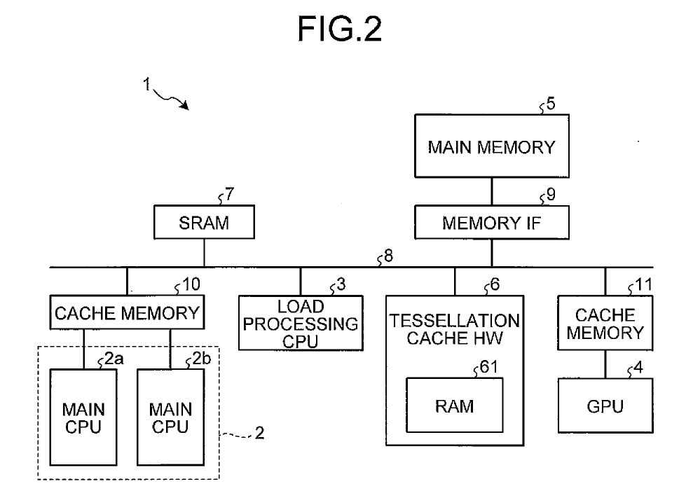

FIG. 2 is a block diagram illustrating the configuration of an image processing apparatus according to the present embodiment to realize the above characterization. As illustrated in FIG. 2, an image processing apparatus 1 includes a plurality (two here) of main CPUs 2a, 2b, a load processing CPU 3, a Graphics Processing Unit (GPU) 4, a main memory 5, a tessellation cache hardware (HW) 6, a Static Random Access Memory (SRAM) 7, and a bus 8.

The tessellation cache HW 6 is connected to the bus 8. The tessellation cache HW 6 is dedicated hardware to perform tessellation processing. The tessellation cache HW 6 performs tessellation processing on Bezier-interpolated vertex data. The tessellation cache HW 6 includes a Random Access Memory (RAM) 61 and stores (caches) data (tessellation data) after the tessellation processing for each sprite. Here, the tessellation cache HW 6 caches tessellation data for each sprite at a logical address having an ID (sprite ID) to identify the sprite as a lower address. That is, the storage destination of tessellation data is determined for each sprite. A more detailed configuration of the tessellation cache HW 6 will be described later.

The main memory 5 is used as a storage area where intermediate data related to reproduction of rich content or frames, which are data to be displayed in a display apparatus (not shown), are stored. The main memory 5 is constituted of, for example, a RAM. The main memory 5 is connected to the bus 8 via a memory interface (memory IF) 9.

The load processing CPU 3 is a CPU for performing load processing. More specifically, the load processing CPU 3 reads a file of rich content input from an external storage apparatus (not shown) or the like, decompresses the read file, separates vertex data contained in the decompressed file as graphic information for each sprite, and stores separated vertex data in the main memory 5 as intermediate data. The load processing CPU 3 is connected to the bus 8.

The main CPU 2a and the main CPU 2b constitute a multi-CPU system and are each connected to a common cache memory 10. The main CPU 2a and the main CPU 2b are each connected to the bus 8 via the cache memory 10. The main CPU 2a and the main CPU 2b will generically be called a main CPU 2. The main CPU 2 performs coordinate conversion processing such as scaling, zooming, and rotation, alignment of vertices, and Bezier interpolation on vertex data for each sprite loaded and stored in the main memory 5. Bezier-interpolated vertex data is sent to the tessellation cache HW 6, where tessellation processing is performed thereon. The main. CPU 2 acquires an execution result (tessellation data) of the tessellation processing from the RAM 61, generates a rendering function based on the acquired tessellation data, and stores the generated rendering function in the SRAM 7.

If tessellation processing has been performed on the same sprite, a tessellation processing result (tessellation data) thereof is stored in the RAM 61. Before performing alignment of vertices, the main CPU 2 makes an inquiry at the tessellation cache HW 6 about whether tessellation data of the sprite to be rendered is cached in the RAM 61. If the relevant tessellation data is cached, the main CPU 2 acquires the tessellation data and generates a rendering function based on the acquired tessellation data. As a notification requesting an inquiry about whether tessellation data of the sprite to be rendered is cached, the main CPU 2 inputs an address in the RAM 61 to be a storage destination if the tessellation data is cached, that is, an address having the sprite ID as a lower address into the tessellation cache HW 6.

The GPU 4 is connected to the bus 8 via a cache memory 11. The GPU 4 performs fill processing including fill processing, alpha-blending processing, and anti-aliasing on the sprite to be rendered based on the rendering function stored in the SRAM 7 and stores an execution result in the main memory 5. Frames stored in the main memory 5 are rendered unchanged in a display apparatus or the like.

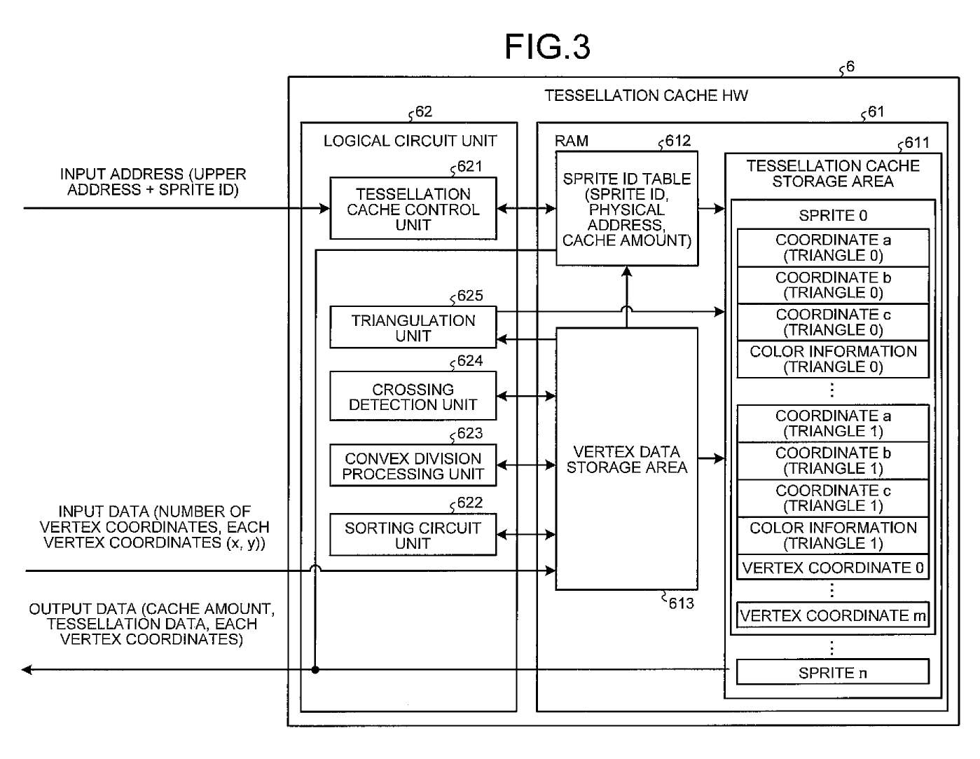

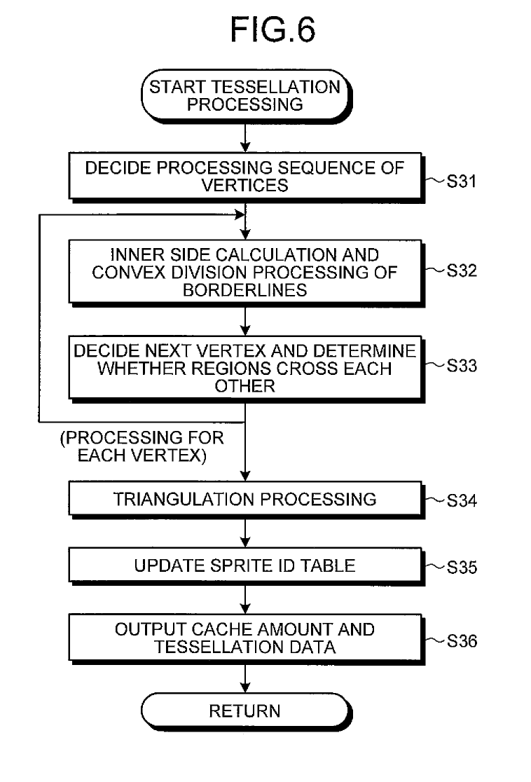

FIG. 3 is a block diagram illustrating the configuration of the tessellation cache HW 6 in more detail. As illustrated in FIG. 6, the tessellation cache HW 6 includes the RAM 61 and a logical circuit unit 62.

In the RAM 61, a tessellation cache storage area 611, which is a storage area to cache tessellation data, is secured. Tessellation data for each sprite cached in the tessellation cache storage area 611 includes Bezier-interpolated vertex data, coordinates (coordinates a to c) constituting primitives (assumed here to be triangles) generated based on the vertex data, and color information specifying the color for each primitive. FIG. 3 shows that tessellation data of a sprite 0 to a sprite n is cached and the sprite 0 includes primitives of a triangle 0 to a triangle 1. FIG. 3 also shows that vertex coordinates 0 to vertex coordinates m are cached as vertex data from which the triangle 0 to the triangle 1 are generated.

The RAM 61 has a sprite ID table 612, which is a table to manage tessellation data cached in the tessellation cache storage area 611, stored therein. More specifically, the sprite ID table 612 associates each sprite ID with the logical address of cache destination of tessellation data, the first physical address of cache destination of tessellation data, and the cache amount. The zero value “0” as the cache amount is associated with a logical address where no tessellation data is cached. The cache amount is a value indicating the data amount and, for example, 1 or m. The logical address of tessellation data is, as described above, an address obtained by adding an appropriate upper address to the sprite ID.

The RAM 61 also has a vertex data storage area 613, which is a storage area for storing intermediate data created when tessellation processing is performed on Bezier-interpolated vertex data, secured therein.

The logical circuit unit 62 includes a tessellation cache control unit 621, a sorting circuit unit 622, a convex division processing unit 623, a crossing detection unit 624, and a triangulation unit 625.

The tessellation cache HW 6 has an address as a request to make an inquiry about whether tessellation data of a desired sprite is cached input thereinto from the main CPU 2. The address that is input may be called an input address. The tessellation cache control unit 621 determines whether the requested tessellation data is cached based on the input address and the sprite ID table 612. If cached, the tessellation cache control unit 621 reads the relevant tessellation data and sends the read data to the main CPU 2 together with the cache amount as output data. If not cached, the tessellation cache control unit 621 sends the cache amount “0” to the main CPU 2 as output data.

The tessellation cache HW 6 has vertex data of the sprite on which tessellation processing should be performed input thereinto together with the number of pieces of vertex data (vertex coordinates) constituting the sprite. The number of vertex coordinates and vertex data that are input may be called input data. Input data is temporarily stored in the vertex data storage area 613. The sorting circuit unit 622 is a circuit that decides the processing sequence to perform subsequent processing such as convex division processing described later based on vertex data and the number of vertex coordinates stored in the vertex data storage area 613. For example, the sorting circuit unit 622 sets the priority in the order of the X coordinate and the Y coordinate and decides the processing sequence of each piece of vertex data based on the priority.

The convex division processing unit 623 is a circuit that makes a convex division of graphics enclosed by borderlines represented by vertex data in the processing sequence decided by the sorting circuit unit 622. New graphics generated by a convex division will be called regions. The crossing detection unit 624 is a circuit that determines whether there are regions crossing each other.

The triangulation unit 625 is a circuit that divides each region into triangles that are output as primitives in the end. Data after division into triangles and vertex data contained in input data and stored in the vertex data storage area 613 is written into the tessellation cache storage area 611 for each sprite.

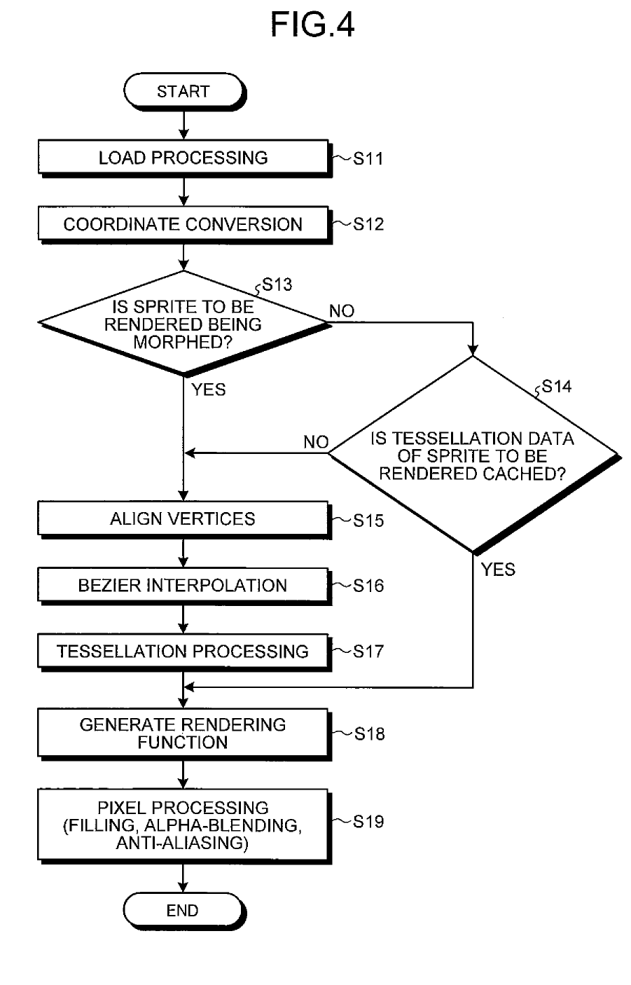

Next, the operation of the image processing apparatus 1 according to the present embodiment will be described. Particularly, the operation when vector graphics is reproduced will be described. FIG. 4 is a flow chart illustrating the operation of the image processing apparatus 1 when vector graphics is reproduced. FIG. 4 shows a flow of rendering operation.

As shown in FIG. 4, first the load processing CPU 3 performs load processing of a content file input from an external storage apparatus or the like and stores vertex data in the main memory 5 for each sprite (step S11). The main CPU 2 performs coordinate conversion processing on vertex data of sprites stored in the main memory 5 and stores vertex data on which coordinate conversion processing has been performed in the main memory 5 (step S12).

Subsequently, the main CPU 2 determines whether the sprite on which coordinate conversion processing has been performed, that is, the sprite to be rendered is being morphed (step S13). Morphing is one technique of computer graphics by which some object is rendered to gradually change to another shape of the object.

If the sprite is not being morphed (step S13, No), the main CPU 2 inputs an input address having the sprite ID of the sprite to be rendered as a lower address into the tessellation cache HW 6 to make an inquiry at the tessellation cache HW 6 about whether tessellation data of the sprite is cached in the RAM 61 (step S14).

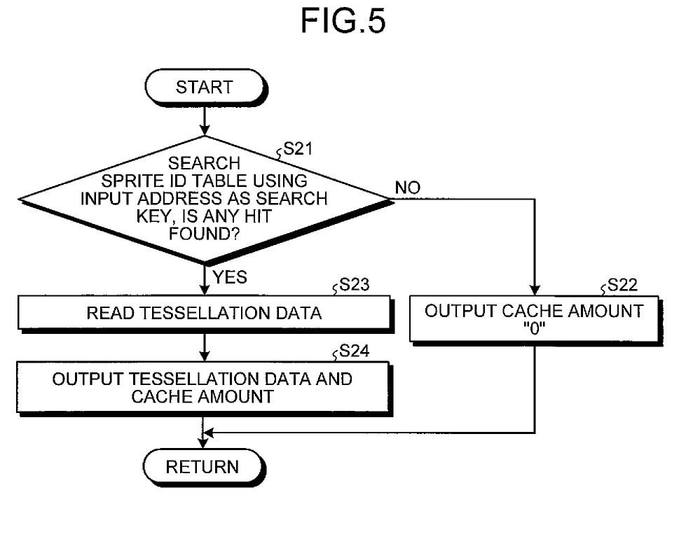

FIG. 5 is a flow chart illustrating the operation of the tessellation cache HW 6 when an input address is input from the main CPU 2.

As shown in FIG. 5, when an input address is input, the tessellation cache control unit 621 searches the sprite ID table 612 using the input address as a search key to determine whether a hit is found in the search (step S21). If the input address is associated with the cache amount “0” in the sprite ID table 612, the tessellation cache control unit 621 determines that no hit is found (step S21, No). If no hit is found (step S21, No), the tessellation cache control unit 621 sends the cache amount “0” to the main CPU 2 (step S22), and the operation thereof is to return.

If a hit is found (step S21, Yes), the tessellation cache control unit 621 reads data of the amount corresponding to the cache amount associated with the input address, that is, tessellation data of the sprite to be rendered from the physical address associated with the input address (step S23) and sends the read tessellation data and the cache amount to the main CPU 2 (step S24). Then, the operation thereof is to return.

Returning to FIG. 4, if tessellation data of the sprite to be rendered is not cached as a result of the inquiry in step S14 (step S14, No), that is, if output data whose cache amount is “0” is received from the tessellation cache HW 6, the main CPU 2 aligns vertices (vertex coordinates) of vertex data on which coordinate conversion processing has been performed so that the vertices can easily be Bezier-interpolated (step S15) and performs Bezier interpolation on aligned vertex data (step S16).

Subsequently, the main CPU 2 inputs Bezier-interpolated vertex data of the sprite to be rendered and the number of vertex coordinates into the tessellation cache HW 6 via the bus 8 so that tessellation processing is performed on the sprite to be rendered (step S17). FIG. 6 is a flow chart illustrating the operation of the tessellation processing in step S17 in more detail.

As shown in FIG. 6, the sorting circuit unit 622 first decides the processing sequence of vertices for vertex data sent from the main CPU 2 and stored in the vertex data storage area 613 (step S31). Then, the convex division processing unit 623 sequentially selects vertex coordinates in the decided processing sequence, calculates the inner side of borderlines, and makes a convex division of surfaces enclosed by borderlines (step S32). The crossing detection unit 624 checks that regions generated by the convex division do not cross each other (step S33). The operations in step S32 and step S33 continue until processing is performed on all vertices included in the sprite to be rendered.

Then, the triangulation unit 625 divides each region generated by the convex division and checked for crossing into one or more triangles as primitives (step S34). Data showing triangles generated after division is stored in the tessellation cache storage area 611 as tessellation data. The tessellation data is stored in an area whose start physical address is associated with the logical address having the sprite ID as a lower address.

Then, the tessellation cache control unit 621 determines the cache amount based on the start physical address where the tessellation data is stored, the number of triangles contained in the tessellation data, and the number of vertex coordinates and associates and records the logical address associated with the physical address where the tessellation data is stored, the calculated physical address, and the cache amount in the sprite ID table 612 (that is, updates the sprite ID table 612) (step S35). The tessellation cache control unit 621 outputs the stored tessellation data and the cache amount of the tessellation data to the main CPU 2 (step S36) and the operation thereof is to return.

Returning to FIG. 4, after receiving the tessellation data and the cache amount, the main CPU 2 generates a rendering function based on the received tessellation data (step S18) and stores the generated rendering function in the SRAM 7. The GPU 4 performs pixel processing based on the rendering function stored in the SRAM 7 (step S19) and causes the main memory 5 to store an execution result before the operation being terminated.

If, in step S14, tessellation data of the sprite to be rendered is already cached (step S14, Yes), that is, if the main CPU 2 receives the tessellation data and the cache amount from the tessellation cache HW 6, alignment of vertices (step S15), Bezier interpolation (step S16), and tessellation processing (step S17) are skipped to move to processing in step S18.

If, in step S13, the sprite to be rendered is being morphed (step S13, Yes), vertex data is changing and tessellation processing needs to be newly performed and thus, processing moves to step S15.

While the coordinate conversion (step S12) is performed after the load processing (step S11) in the above description, the load processing is performed by the dedicated CPU (load processing CPU 3) in the present embodiment to hide latency necessary for the load processing. Therefore, the load processing (step S11) and the coordinate conversion (step S12) and processing thereafter are performed simultaneously in parallel.

While the main memory 5 is included in the image processing apparatus 1 in the above description, but the main memory 5 may be provided outside the image processing apparatus 1 so that the main memory 5 is accessed via the bus 8 and the memory IF 9.

While tessellation data for each sprite cached in the tessellation cache storage area 611 contains Bezier-interpolated vertex data in the above description, tessellation data may not contain Bezier-interpolated vertex data. Moreover, the cache amount is assumed to be, for example, 1 (value corresponding to the number of primitives) and m (value corresponding to the number of pieces of vertex data), but if tessellation data should not contain Bezier-interpolated vertex data, the cache amount can be represented by only 1. Any value indicating the amount of tessellation data (data amount) may be used as the cache amount.

While Bezier interpolation is performed as interpolation processing of vertex data in the above description, the technique of interpolation processing is not limited to the Bezier interpolation.

According to the present embodiment, as described above, the tessellation cache HW 6 (tessellation processing unit) includes the RAM 61 that stores generated primitives for each sprite and if primitives of a sprite to be rendered are stored in the RAM 61 and the main CPU 2 skips interpolation processing on vertex data of the sprite and generates a rendering function to render the vector image based on the stored primitives and therefore, there is no need to perform tessellation processing again on a sprite on which tessellation processing has been performed once so that tessellation processing can be performed efficiently. Moreover, there is no need to perform interpolation processing and vertex alignment for the interpolation processing on a sprite on which tessellation processing has been performed once.

Moreover, according to the present embodiment, the image processing apparatus 1 further includes the load processing CPU 3 (sub CPU) that loads vertex data of a vector image into the main memory 5 and the main CPU 2 performs interpolation processing on vertex data of the vector image loaded into the main memory 5 and therefore, latency necessary for load processing can be hidden so that the processing speed can be improved.

While the RAM 61 is provided inside the tessellation cache HW 6 in the above description, the RAM 61 may be provided outside the tessellation cache HW 6 at any location accessible from the tessellation cache HW 6.

The CPU 2 and the load processing CPU 3 in the above description are realized by executing a software program (hereinafter, referred to as a program). The program is stored in the ROM or the like inside the image processing apparatus and expanded into a predetermined area of the main memory for execution. As a computer program product, the program is recorded or stored in a portable medium such as a flexible disk and CD-ROM, or a recording medium such as a hard disk in its entirety or partially with only part of program code. The program is read by a computer and then, all or part of the program is executed. Or, all or part of code of the program can be distributed or provided via a communication network. The user can download the program via a communication network to install the program on a computer or install the program on a computer from a recording medium to easily realize an image processing apparatus according to the present embodiment.

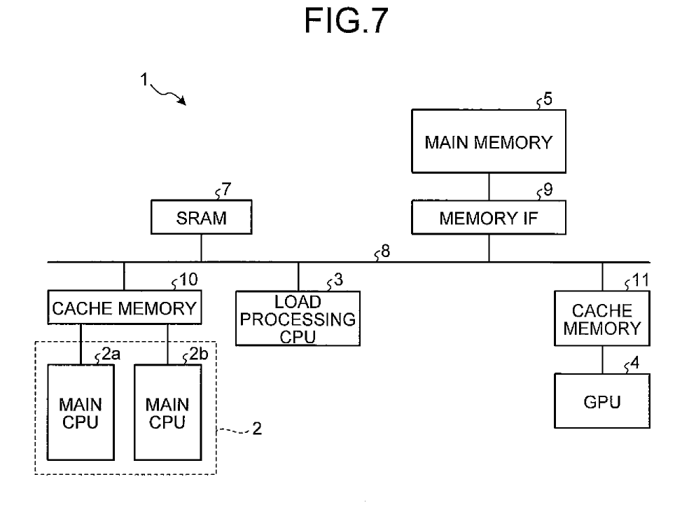

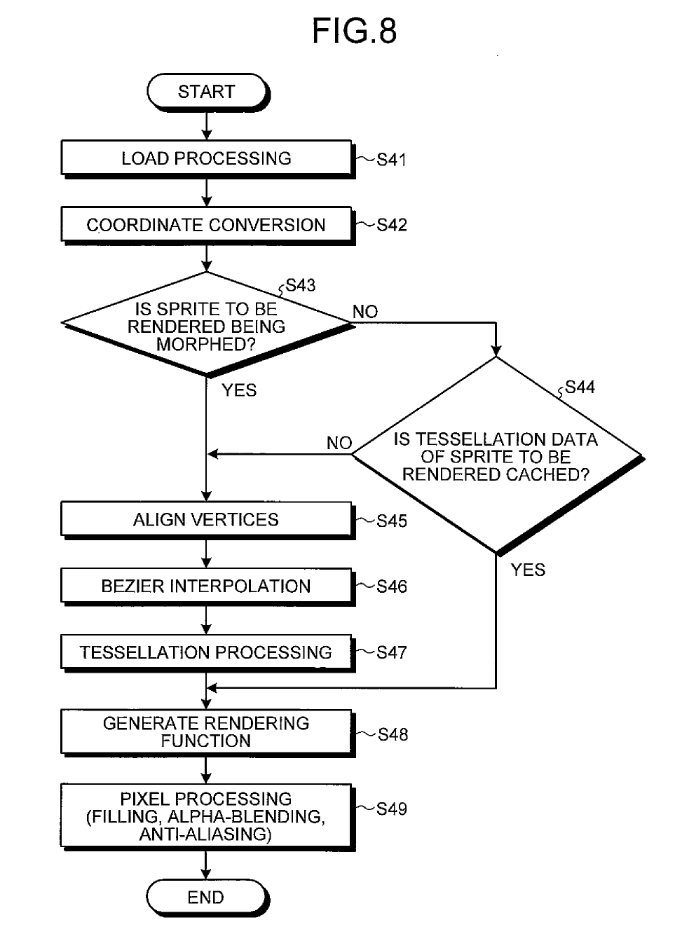

Next, an image processing apparatus according to the second embodiment will be described with reference to FIGS. 7 and 8. FIG. 7 is a block diagram illustrating the configuration of the image processing apparatus according to the present embodiment. The same numerals are attached to the same components as those in the first embodiment to omit a description thereof.

The second embodiment is different from the first embodiment in that the tessellation cache HW 6 is not included. In the first embodiment, the tessellation cache HW 6 performs tessellation processing and stores (caches) data after the tessellation processing. In the second embodiment, by contrast, the main CPU 2 performs tessellation processing and the main memory 5 stores (caches) data (tessellation data) after the tessellation processing. That is, processing described below with reference to FIG. 8 and performed by the main CPU 2 is realized by a software program (hereinafter, referred to as a program) being executed by the main CPU 2. The program is stored in the ROM or the like in the image processing apparatus and expanded into a predetermined area of the main memory for execution.

The main CPU 2 performs coordinate conversion processing such as expansion, contraction, and rotation, alignment of vertices, and Bezier interpolation on vertex data for each sprite loaded and stored in the main memory 5. Further, the main CPU 2 performs tessellation processing on Bezier-interpolated vertex data and stores (caches) data (tessellation data) after the tessellation processing in the main memory 5 and also generates a rendering function based on the tessellation data.

If tessellation processing has been performed on the same sprite, tessellation data thereof is cashed in the main memory 5. Before performing alignment of vertices, the main CPU 2 makes an inquiry about whether tessellation data of the sprite to be rendered is cached in the main memory 5. If the relevant tessellation data is cached, the main CPU 2 acquires the tessellation data and generates a rendering function based on the acquired tessellation data.

The main memory 5 is used as a storage area where intermediate data related to reproduction of rich content or frames, which are data to be displayed in a display apparatus (not shown), are stored. Further, as described above, the main memory 5 stores (caches) data (tessellation data) on which tessellation processing has been performed by the main CPU 2. Tessellation data for each sprite cached in the main memory 5 includes Bezier-interpolated vertex data, coordinates (coordinates a to c) constituting primitives (assumed here to be triangles) generated based on the vertex data, and color information specifying the color for each primitive.

Next, the operation of an image processing apparatus 2 according to the present embodiment will be described with reference to FIG. 8. Here, particularly the operation when vector graphics is reproduced will be described. FIG. 8 is a flow chart illustrating the operation of the image processing apparatus when vector graphics is reproduced.

The processing in steps S41, S42, and S43 is the same as illustrated in FIG. 4 (steps S11, s12, and S13) and thus, a description thereof is omitted.

If, in step S43, the sprite to be rendered is not being morphed (step S43, No), the main CPU 2 checks whether tessellation data of the sprite to be rendered is cached. If, as a result, no tessellation data of the sprite to be rendered is cached (step S44, No), the main CPU 2 aligns each vertex (vertex coordinates) of vertex data on which coordinate conversion processing has been performed so as to make Bezier interpolation easier (step S45) and then performs Bezier interpolation on the aligned vertex data (step S46).

Subsequently, the main CPU 2 performs tessellation processing on the sprite based on Bezier-interpolated vertex data of the sprite to be rendered and the number of vertex coordinates (step S47). At this point, the main CPU 2 caches data after the tessellation processing in the main memory 5.

Subsequently, the main CPU 2 generates a rendering function based on the data (tessellation data) after the tessellation processing (step S48) and causes the main memory 5 to store an execution result as frames before terminating the operation.

If, in step S44, tessellation data of the sprite to be rendered is already cached in the main memory 5 (step S44, Yes), alignment of vertices (step S45), Bezier interpolation (step S46), and tessellation processing (step S47) are skipped to move to processing in step S48.

If, in step S43, the sprite to be rendered is being morphed (step S43, Yes), vertex data is changing and tessellation processing needs to be newly performed and thus, processing moves to step S45.

According to the present embodiment, as described above, if tessellation data of the sprite to be rendered is stored in the main memory 5, the main CPU 2 skips interpolation processing on vertex data of the sprite and generates a rendering function to render the vector image based on the stored tessellation data. Accordingly, the same effect as that of the first embodiment is achieved.

While the coordinate conversion (step S42) is performed after the load processing (step S41) in the above description, the load processing is performed by the dedicated CPU (load processing CPU 3) in the present embodiment to hide latency necessary for the load processing. Therefore, the load processing (step S41) and the coordinate conversion (step S42) and processing thereafter are performed simultaneously in parallel.

A program performing the operation described above is recorded or stored, as a computer program product, in a portable medium such as a flexible disk and CD-ROM, or a recording medium such as a hard disk in its entirety or partially with only part of program code. The program is read by a computer and then, all or part of the program is executed. Or, all or part of code of the program can be distributed or provided via a communication network. The user can download the program via a communication network to install the program on a computer or install the program on a computer from a recording medium to easily realize an image processing apparatus according to the present embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus, comprising:
a processing unit that performs interpolation processing on vertex data of a vector image for each sprite;
a tessellation processing unit, which is hardware to perform tessellation processing that generates primitives based on the vertex data from the processing unit;
a tessellation data storage unit that stores the primitives generated by the tessellation processing unit for each sprite, wherein the processing unit generates a rendering function to render the vector image based on the stored primitives in the tessellation data storage unit, the stored primitives is generated by rendering processing prior to the present rendering processing.

2. An image processing apparatus of claim 1, wherein
the tessellation data storage unit stores the generated primitives at a logical address having an identification number of the sprite of the primitives.

3. An image processing apparatus of claim 2, wherein the logical address having the identification number of the primitives for each sprite as a lower address.

4. An image processing apparatus of claim 1, wherein
the tessellation processing unit
includes a tessellation data storage unit management table that associates, for each sprite in the tessellation data storage unit, a logical address of a storage location of the primitives with a data amount of the primitives stored at the logical address of the storage location and
when the logical address is input from the processing unit, the tessellation data storage unit determines whether the primitives are stored at the input logical address based on the tessellation data storage unit management table.

5. An image processing apparatus of claim 2, wherein
the tessellation processing unit
includes a tessellation data storage unit management table that associates, for each sprite in the tessellation data storage unit, a logical address of a storage location of the primitives with a data amount of the primitives stored at the logical address of the storage location and
when the logical address is input from the processing unit, the tessellation data storage unit determines whether the primitives are stored at the input logical address based on the tessellation data storage unit management table.

6. An image processing apparatus of claim 3, wherein
the tessellation processing unit
includes a tessellation data storage unit management table that associates, for each sprite in the tessellation data storage unit, a logical address of a storage location of the primitives with a data amount of the primitives stored at the logical address of the storage location and
when the logical address is input from the processing unit, the tessellation data storage unit determines whether the primitives are stored at the input logical address based on the tessellation data storage unit management table.

7. An image processing apparatus of claim 4, wherein
the processing unit inputs the logical address corresponding to the sprite to be rendered into the tessellation processing unit in case the sprite to be rendered is not being morphed.

8. An image processing apparatus of claim 5, wherein
the processing unit inputs the logical address corresponding to the sprite to be rendered into the tessellation processing unit in case the sprite to be rendered is not being morphed.

9. An image processing apparatus of claim 6, wherein
the processing unit inputs the logical address corresponding to the sprite to be rendered into the tessellation processing unit in case the sprite to be rendered is not being morphed.

10. An image processing apparatus of claim 1, further comprising:
a second processing unit that loads the vertex data of the vector image into a main memory, wherein
the processing unit performs the interpolation processing on the vertex data of the vector image loaded into the main memory.

11. A non-transitory computer readable medium comprising instructions that cause a computer to:
check whether primitives of a sprite to be rendered is generated by rendering processing prior to the present rendering processing and are stored;
if the primitives of the sprite to be rendered are stored, generate a rendering function to render a vector image based on the stored primitives; and
if the primitives of the sprite to be rendered are not stored, generate the primitives based on vertex data of the sprite to be rendered and generate the rendering function to render the vector image based on the primitives.

12. A computer readable medium of claim 11, wherein instructions further cause the computer to
check whether the primitives of the sprite to be rendered is generated by rendering processing prior to the present rendering processing and are stored associated with the sprite in case the sprite to be rendered is not being morphed.

13. A computer readable medium of claim 12, wherein instructions further cause the computer to generate the primitives based the vertex data of the sprite to be rendered and, to store the primitives associated with the sprite.

14. A computer readable medium of claim 13, wherein instructions further cause the computer to store the generated primitives at a logical address having identification number of the sprite of the primitives.

15. A computer readable medium of claim 14, wherein the logical address having the identification number of the primitives as a lower address.

16. A computer-implemented method comprising:
checking whether primitives of a sprite to be rendered is generated by rendering processing prior to the present rendering processing and are stored associated with the sprite;
if the primitives of the sprite to be rendered are stored, generating a rendering function to render a vector image based on the stored primitives; and
if the primitives of the sprite to be rendered are not stored, generating the primitives based on vertex data of the sprite to be rendered and generating the rendering function to render the vector image based on the primitives.

17. The method of claim 16, wherein checking whether the primitives of the sprite to be rendered is generated by rendering processing prior to the present rendering processing and are stored in case the sprite to be rendered is not being morphed.

18. The method of claim 17, wherein the primitives are generated based the vertex data of the sprite to be rendered and, the primitives are stored associated with the sprite.
